(19) United States
(12) Patent Application Publication
(10) Pub. No.: US 2008/0152184 A1
(43) Pub. Date: Jun. 26, 2008

(54) COLLAPSIBLE SPEAKER SYSTEM

(76) Inventor: Anthony Bongiovi, Port St. Lucie, FL (US)

Correspondence Address: DON J. PELTO;Sheppard, Mullin, Richter & Hampton LLP, 1300 I STREET, NW, 11TH FLOOR EAST, WASHINGTON, DC, 20006, US

(21) Appl. No.: 12/042,512

(22) Filed: Mar. 5, 2008

Related U.S. Application Data
(63) Continuation-in-part of application No. 11/703,216, filed on Feb. 7, 2007.
(60) Provisional application No. 60/765,722, filed on Feb. 7, 2006.

(51) Int. Cl. H04R 1/02

(52) U.S. Cl. 381/389

(57) ABSTRACT

The present invention is directed to a speaker system. The system includes: a speaker that comprises a magnet and a basket coupled to the magnet, the basket is configured to collapse upon impact with an external object; a panel having a first side coupled to the basket of the speaker and a second side facing a space; and a groove being disposed on the first side of the panel, wherein the groove is adjacent to an outer perimeter of the basket where the basket is coupled to the speaker.

### CROSS-REFERENCE TO RELATED APPLICATIONS

The present application is a continuation-in-part and claims the benefit, under 35 U.S.C. § 120, of U.S. patent application Ser. No. 11/703,216, filed Feb. 7, 2007, which is related to and claims the benefit under 35 U.S.C, § 119(e) of U.S. Provisional Patent Application Ser. No. 60/765,722 filed Feb. 7, 2006, which is expressly incorporated fully herein by reference.

### FIELD OF THE INVENTION

The present invention relates to one or more acoustic speakers mounted on a surface and specifically a panel, and more specifically where the panel comprises a vehicle headliner. The present invention more particularly relates to a collapsible acoustic speaker system in a vehicle headliner with headliner grooves encircling the outer perimeter of the baskets of the headliner speakers.

### BACKGROUND OF THE INVENTION

The presentation of quality sound in moving motor vehicles is particularly challenging due to the high noise environment therein. This is compounded by the fact that speakers in vehicles, due to space considerations, are often placed in less than ideal positions. This can result in speaker locations that require the sound produced by the speakers to bounce off various surfaces before reaching the occupants of the vehicle. One solution to this problem is to place speakers in the headliner of the motor vehicle, thus allowing the sound to reach the occupants of the vehicle unimpeded.

Each year, head injuries are responsible for tens of thousands of deaths and hundreds of thousands of hospitalizations in the United States. Many of these injuries are the result of motor vehicle crashes. During a crash of a vehicle an occupant of the vehicle may strike his head upon a conventional speaker mounted in the headliner of a motor vehicle acid could suffer serious injuries.

Therefore, there is a need for a speaker panel system and specifically a headliner speaker system in a motor vehicle that when impacted by the body or head of an occupant, causes minimal injury to that occupant. This speaker could be mounted on embedded in, or otherwise associated with the headliner of a motor vehicle. It could also be mounted in or on any other surface where collapsibility would be required to minimize injury. This includes any interior or exterior space or surface, and specifically includes panels and specifically the headliners in the interiors of vehicles, such as airplanes, helicopters, trains, and boats, for example. This also includes other interior or exterior surfaces of, for example, vehicles, buildings or other objects, and specifically panels, including walls, ceilings, floors and children's toys, helmets, and furniture, for example, tables, chairs, sofas, and headboards for beds.

There is also a need for a headliner in a motor vehicle with one or more speakers that when impacted by the body or head of an occupant, causes minimal injury to that occupant. The headliner could also be used in other situations, such as in other modes of transportation such as airplanes, trains, boats, ships and helicopters.

### SUMMARY OF THE INVENTION

According to one embodiment of the present invention, the speaker system includes: a speaker having a magnet and a basket coupled to the magnet, the basket is configured to collapse upon impact with an external object; a panel having a first side coupled to the basket of the speaker and a second side facing a space; and a groove being disposed on the first side of the panel, wherein the groove is adjacent to an outer perimeter of the basket where the basket is coupled to the speaker.

In one embodiment of the present invention, the panel comprises a headliner. In vet another embodiment, the headliner comprises a vehicle headliner. In yet another embodiment, the space that the second side of the headliner faces is the interior of a vehicle.

In one embodiments the basket is configured to have a head injury criterion (HIC) of less than 1,000 when impacted by the external object at a speed up to 25 km/hour, wherein the HIP is calculated by the following formula:

$$HIC = 0.75446 ( {[ \frac{1}{( {t}_{2} - {t}_{1} )} {\int }_{{t}_{2}}^{{t}_{1}} a d t ]}^{2.5} ( {t}_{2} - {t}_{1} ) ) + 166.4$$

and wherein the term a is the resultant acceleration of the external object expressed as a multiple of g (the acceleration of gravity), and t1 and t2 are any two points in time during the impact which are separated by no more than a 36 millisecond time interval.

In another embodiment, the groove has a larger radius than the basket. The groove may partially or completely encircle the basket. The groove may also run generally parallel to the outer perimeter of the basket.

In still another embodiment, the basket is formed of a substance selected from one or more of the group consistency of, aluminum, steel, titanium, any other metal, plastic, plastic composite, polypropylene, polycarbonate, and foam.

In still another embodiment, the headliner includes a first, a second, and a third layer, wherein the second layer is between the first and third layers, and wherein the first and third lavers comprise a same material and the second layer is an insulation layer. The first and second layers may comprise fiberglass and the groove may be disposed only on the first and second layers.

In still another embodiment, the groove has a diameter of approximately 200 mm. The groove may have a width of approximately 10 mm.

According to one embodiment of the present invention , a speaker system for a vehicle comprising: a speaker having basket configured to collapse upon impact with an external object; and a panel having a groove being disposed on a first side of the panel, wherein the groove is adjacent to an outer perimeter of the basket where the basket is coupled to the speaker.

In one embodiment of the present invention, the panel comprises a headliner. In yet another embodiment, the headliner comprises a vehicle headliner. In yet another embodiment, the space that the second side of the headliner faces is the cabin of a vehicle. In yet another embodiment, the panel may comprise, or be separately attached to, one or more of the group consisting of interior door moldings front and/or rear), package tray, pillar/column/support structures, seat backs, dashboard, lift gates (rear doors), trunk, firewall (font or rear), and interior kick panels of a vehicle and specifically a motor vehicle such as an automobile.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and case of illustration these drawings are not necessarily made to scale.

FIG. 1 illustrates a cross section of a speaker according to one embodiment of the present invention.

FIG. 7 and FIG. 3 illustrate example environments in which a speaker system of the present invention can be implemented.

FIG. 4 and FIG. 5 illustrate cross sections of speaker systems according to embodiments of the present invention.

FIG. 6 illustrates an example installation schematic for the speaker system shown in FIG, 2 according to one embodiment of the present invention.

The Figures are not intended to be exhaustive or to limit the invention to the precise form disclosed. It should be understood that the invention can be practiced with modification and alteration, and that the invention be limited only by the claims and the equivalents thereof

### DETAILED DESCRIPTION OF THE PREFERRED EMBODIMENT

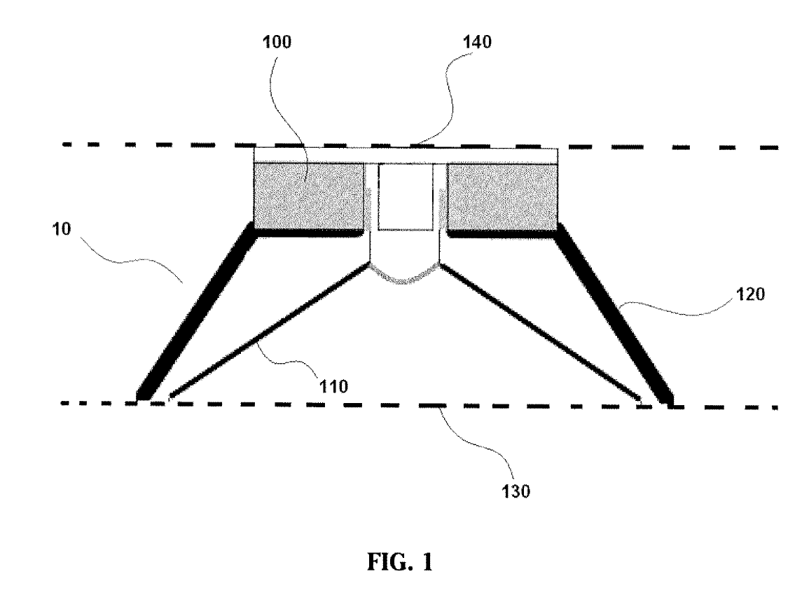

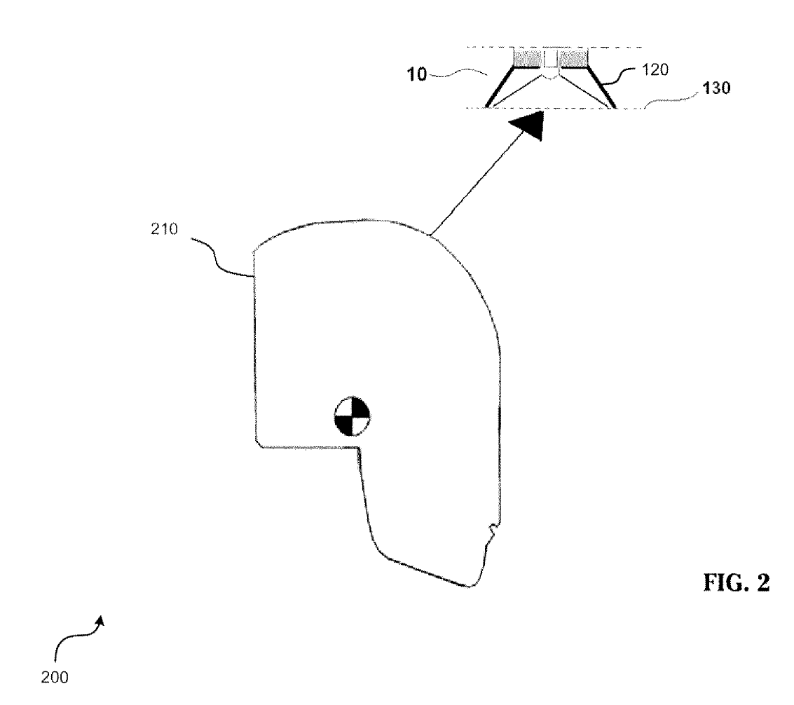

FIG. 1 illustrates a collapsible speaker 10 according to one embodiment of the present invention. Referring now to FIG. 1, speaker 10 includes a magnet 100, a cone 110, a basket 120, a bottom side 130, and a top side 140. Speaker 10 may advantageously be connected to or otherwise associated with an audio source such as an amplifier, receiver, cellular telephone, or any other device capable of producing audio signals. Speaker 10 may be attached to, embedded in, or otherwise associated with a panel and specifically the headliner of a vehicle such as a car, truck, van, or other automobile. Additionally, the speaker 10 may be associated with any other panel or surface where, for example, there is a potential for impact with a human or other fragile object, and it is desirable to minimize injuries or damage. This includes any interior or exterior space or surface, and specifically includes panels and specifically the headliners in the interiors of vehicles, such as airlines, helicopters, trains, and boats, for example. This also includes other interior or exterior surfaces of, for example, vehicles, buildings or other objects, and specifically panels, including walls, ceilings, floors and children's toys, helmets, and furniture, for example, tables, chairs, sofas, and headboards for beds. In vet another embodiment, the panel may comprise, or be separately attached to, one or more of the group consisting of interior door moldings (front and/or rear), package tray, pillar/column/support structures, seat backs, dashboard, lift gates (rear doors), trunk, firewall (front or rear), and interior kick panels of a vehicle and specifically a motor vehicle such as an automobile.

FIG. 2 illustrates an example environment 200 where a speaker system and specifically, a headliner-speaker system 205 is being implemented according to one embodiment of the present invention. Referring now to FIG. 2, when environment 200 is involved in a collision, a headform 210 may collide with a bottom side 130 of speaker 10 at a speed up to 25 km/hour. In a conventional headliner-speaker system, the head injury criterion (HIC) is much greater than 1000 HIC which is a metric that measure the amount of injury caused to the head. However, in the same collision scenario, headliner-speaker system 205 is configured to have a HIC of less than 1000. HIC is calculated using the following formula:

$$HIC = 0.75446 ( {[ \frac{1}{( {t}_{2} - {t}_{1} )} {\int }_{{t}_{2}}^{{t}_{1}} a d t ]}^{2.5} ( {t}_{2} - {t}_{1} ) ) + 166.4$$

The term ‘a’ in the above equation is the resultant acceleration of the headform expressed as a multiple of ‘g’ (the acceleration of gravity), and t1 and t2 are any two points in time during the impact which are separated by not more than a 36 ms time interval.

When a traditional speaker is impacted, the basket does not properly deform, and can cause significant injury. Thus, in one embodiment, basket 120 is configured to be deformable, when impacted by headform 10 or the body to reduce injury upon impact. In one embodiment basket 120 is configured to revert to its original shape from a deformed state that is caused by the impact.

Basket 120 may advantageously be formed of one or more substance selected from the group comprising, but not limited to, aluminum, steel, titanium, any other metal plastic, plastic composite, polypropylene, polycarbonate, and foam. Basket 120 is preferably strong enough to maintain its shape in a manner conducive to producing sound. In one embodiment, basket 120 may be constructed using a certain gauge of metal, or thickness of other material that is strong enough to maintain its shape for acoustic purposes, but yet weak enough to deform upon impact. Alternatively, basket 120 can be made to deform by creating weak spots such that those spots would give way upon impact. In this way, basket 120 will cause minimal head injury. To determine the HIC value of a particular speaker, one would construct a prototype of the speaker, simulate an impact between the prototype speaker and a headform and calculate the resultant HIC. As mentioned, conventional speakers would yield an HIC value of more than 1000. Whereas, headliner-speaker system 205 constructed according to the embodiments of the present invention. preferably has an HIC value of about 1000 or less.

In one embodiment, speaker 10 may have an about 57 mm diameter at the point where the circumference of the basket 120 is largest and may be about 13 mm tall. In one example of the present invention, such a speaker 10 may also comprise one or more of an impedance of about 8 ohms, a resonant frequency of about 280 Hertz, a frequency range from about 150 Hertz to about 9,000 Hertz, and a sensitivity of about 86 decibels. In one example of the present invention, basket 120 of speaker 10 may be formed of an appropriate gauge of aluminum. In this configuration, the aluminum should be strong enough to maintain the shape of the basket for acoustic purposes, yet weak enough to deform upon impact. Although specific dimensions are discussed above, one skilled in the art would understand that other dimensions could also be employed.

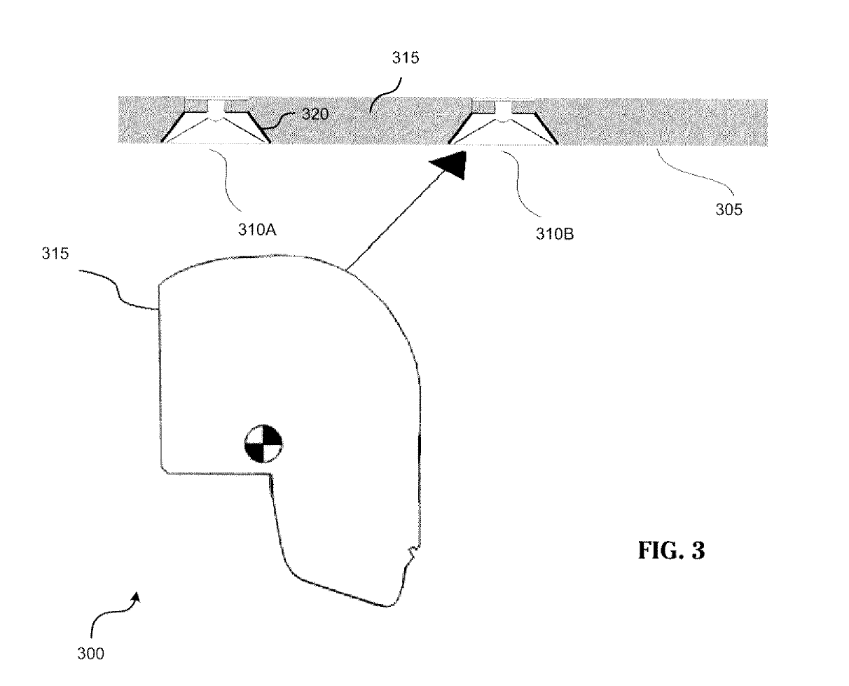

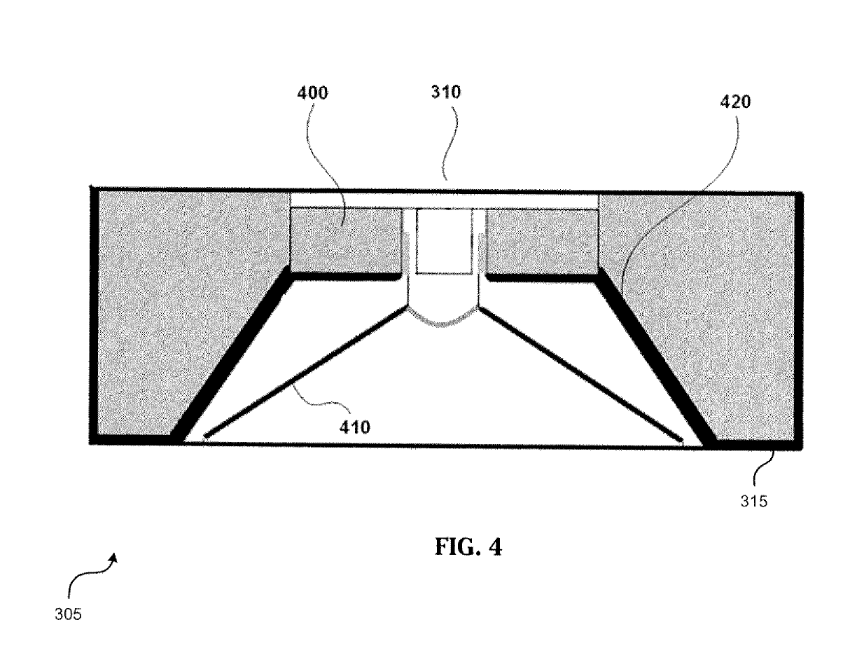

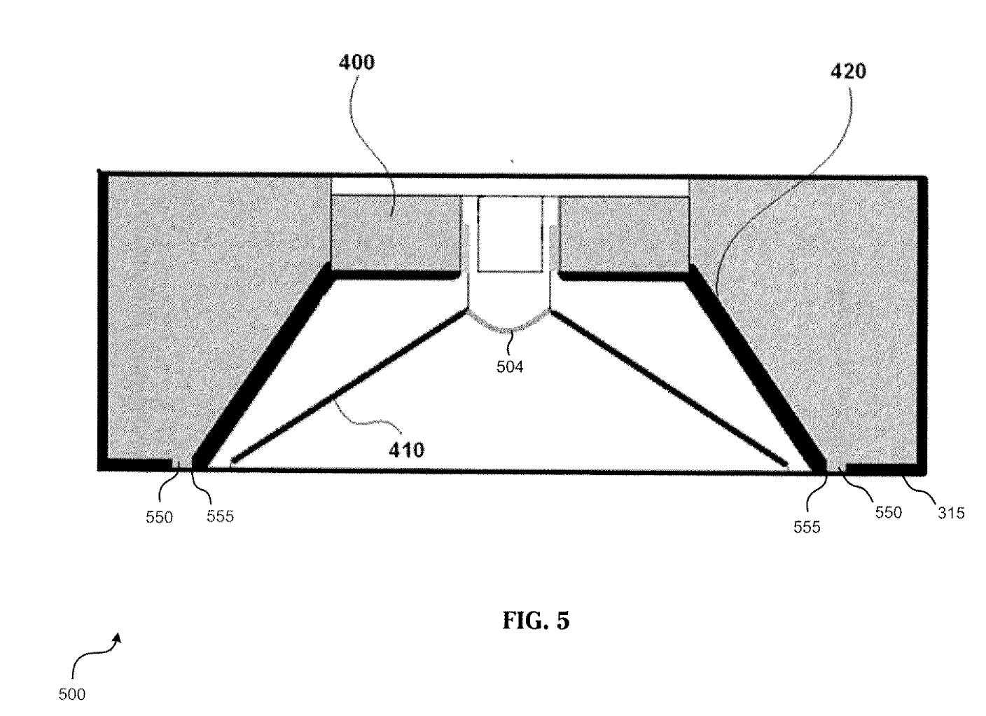

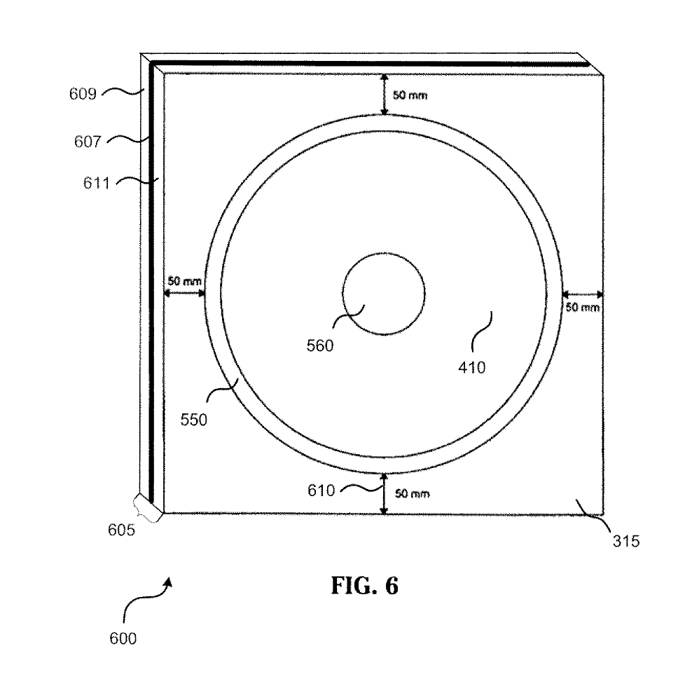

FIG. 3 illustrates an example environment 300 where a speaker system and specifically, a headliner-speaker system 305 is implemented according to one embodiment of the present invention. Referring now to FIG. 3 system 305 includes a first speaker 310A, a second speaker 310B, and a headliner 315. Both speakers 310A and 310B are similar to speaker 10 and may include one or more features of speaker 10. As shown, speakers 310 are mounted on or embedded within the panel and specifically the headliner 315. Although, headliner 315 is shown to have two speakers, more than or less than two speakers may be implemented. When environment 300 is involved in a collision, a headform 315 may collide with a basket 320 of speaker 310A or 310B at speed up to 25 km/hour. Similar to basket 120, basket 320 is configured to be collapsible and may include one or more features of basket 320. In one embodiment, during a collision, the resultant HIC of headliner-speaker system 305 is less than about 1,000 according to the HIC equation discussed above. This is mainly due to the collapsibility feature of basket 320.

FIG. 4 illustrates a sectional view of a panel speaker system and specifically, a headliner-speaker system 305 according to one embodiment of the present invention. System 305 includes speaker 310 and headliner 315. In one embodiment, speaker 310 comprises a magnet 400, a cone 410, and a basket 420. In one embodiment, basket 420 is deformable and may include one or more features of basket 120. Specifically, basket 420 is configured to be deformable when impacted by an object to reduce the injury caused from the impact. Basket 420 can also be configured to return to its original shape from a deformed state caused by an impact.

Basket 420 may be formed of a material selected from the group comprising, but not limited to, aluminum, steel, titanium, any other metal, plastic, plastic composite, polypropylene, polycarbonate, and foam. Regardless of the material used, basket 420 should be strong enough to maintain its shape in a manner conducive to producing sound, but should also be constructed in a manner that allows it to deform when impacted. In one embodiment, basket 420 is constructed using a suitable gauge of metal or thickness of other material that is strong enough to maintain its shape for acoustic purposes, but vet weak enough to deform upon impact, Basket 420 can be configured to deform by creating weak spots in basket 420 such that those spots would deform or collapse upon impact. In one embodiment headliner-speaker system 305 has an IC value of about 1000 or less.

In one embodiment, speaker 310 may have an about 57 mm diameter at the point where the circumference of the basket 420 is at its largest. Speaker 310 may be, in one embodiment, about 13 mm tall and may have one or more of the following characteristics: and impedance of about 8 ohms, a resonant frequency of about 250 Hertz, a frequency range of about 150 Hertz to about 9,000 Hertz, and/or a sensitivity of around about 86 decibels. In one embodiment, basket 420 of speaker 310 is formed of an appropriate gauge of aluminum. In this configuration, the aluminum should be strong enough to maintain its shape for acoustic purposes, yet preferably weak enough to deform upon impact.

FIG. 5 illustrates a sectional view of speaker system and specifically, a headliner-speaker system 500 according to one embodiment of the present invention. Headliner-speaker system 500 is similar to system 305 and may incorporate one or more features of system 305. Referring now to FIG. 5, system 500 includes speaker 310 mounted on or embedded within a panel and specifically a headliner 315. As shown, system 500 also comprises a groove 550 that partially or completely surrounds a rim or outer perimeter 555 of basket 420 (where basket 420 is in direct contact with headliner 315). Groove 550 may be located at some distance away from the rim 555 of basket 420. In one specific embodiment, groove 550 is located next to rim 555. Since basket 420 is directly coupled to headliner 315, headliner 315 is an extension of basket 420 and thus help prorogate frequencies emitted by basket 420.

FIG. 6 illustrates an example layout for a system and specifically, a headliner-speaker system 500 according to one embodiment of the present invention. Referring now to FIG. 6, system 500 includes an audio driver motor 505 that is about 20 mm in diameter, and a surface and specifically a panel 605 that comprises a headliner 315. Panel 605 may comprise, in one embodiment, a thin layer of a foam 607 sandwiched between two layers; rear layer 609 and front layer 611. In one embodiment, layers 607, 609, and 611 have a combined thickness range of about 2 to about 10 mm. In one specific embodiment, the layers 607, 609, and 611 have a combined thickness of about 3 mm. Layers 607 and 611 can be made with fiberglass or other suitable panel or headliner material that is sufficiently rigid to transmit acoustic energy. This includes any interior or exterior space or surface, and specifically includes panels and specifically the headliners in the interiors of vehicles, such as airplanes, helicopters, trains, and boats, for example. This also includes other interior or exterior surfaces of, for example, vehicles buildings or other objects, and specifically panels, including walls, ceilings, floors and children's toys, helmets, and furniture, for example, tables, chairs, sofa, and headboards for beds. Each of the layers 60l, 609, and 611 may be, in one embodiment, fastened or glued to each other with, for example, epoxy or other adhesive material.

In one embodiment, panel 605 is tuned for optimum low frequency response by decoupling the rear layer 609 from the front layer 611. Low frequency response is improved probably because of the material reduction in panel 605. This can be achieved by placing, and, in a particular embodiment, milling, a groove 550 through the rear layer 609 and the foam layer 607. In one embodiment, the groove may be about 10 mm wide. In another embodiment, the groove maybe about 200 mm in diameter. In one embodiment, layer 611 is left intact and groove 550 is not milled onto the surface of layer 611. Groove 550 can be disposed onto layers 607 and 609 using various means such as, for example, a router, or it could be molded into the headliner during manufacture. It should be noted that care should be taken during this step to insure that the front layer 611 is not damaged. Additionally, groove 550 may have a width ranging from about 5 to about 15 mm. That width, in one embodiment, may be variable and be applicable to a continuous or, alternatively, discontinuous groove 550 In one embodiment, groove 50 runs generally parallel to the outer perimeter of the basket.

In one embodiment, groove 550 is spaced about 50 mm or more from the sides of the panel, measuring from the outer edge of groove 550, from the closest side or edge of panel 605 or other installation 503. Additionally, in applications with multiple speakers, each groove may have a minimum distance of about 50 mm from any other groove, measuring from the outer edge of one groove to the outer edge of the other groove.

As shown in FIG. 6, groove 550 may, in one embodiment, completely encircle the outer perimeter or rim of basket 410. In one specific embodiment, groove 550 may substantially or partially encircle the outer perimeter of basket 410. Groove 550 may also have other shapes such as an ellipse, square, triangle, or octagon, etc. Groove 550 may also be partially or completely continuous or, alternatively, discontinuous. The median, outer, or inner diameter of groove 50 can be of any appropriate diameter and in a specific embodiment, may have a range of about 50 mm to about 300 mm, depending on the size of basket 410. That diameter, in one embodiment, may be variable and be applicable to a continuous or, alternatively discontinuous groove 550. In one specific embodiment, groove 550 has an outer diameter of about 200 mm.

Speaker assembly 305 can be repeated as many times as space will allow on a given panel to achieve the desired overall sound level from the panel Additionally, using these installation specifications will insure optimum imaging for an installation in which multiple drivers represent separate channels of a multiple channel signal (e.g., Dolby® 7.1 Surround Sound).

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, hut the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or mores” “at least,” “but not limited to” or other like phrases in some instances shall not be read to mean that the narrower ease is intended or required in instances where such broadening phrases may be absent.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A speaker system comprising:
a speaker comprising:
a magnet,
a basket coupled to the magnet, the basket is configured to collapse upon impact with an external object;
a panel having a first side coupled to the basket of the speaker and a second side facing a space; and
a groove being disposed on the first side of the panel, wherein the groove is adjacent to an outer perimeter of the basket where the basket is coupled to the speaker.

2. The speaker system of claim 1, wherein the panel comprises a headliner.

3. The speaker system of claim 2, wherein the headliner comprises a vehicle headliner.

4. The speaker system of claim 3, wherein the space that the second side of the headliner faces is the interior of the vehicle.

5. The speaker system of claim 1, wherein the panel is selected from one or more of the group consisting, of walls, ceilings, floors and furniture,

6. The speaker system of claim 1 wherein the panel is attached to a vehicle.

7. The speaker system of claim 6, wherein the panel is selected from one or more of the group consisting of interior door moldings package tray, pillar/column/support structures scat backs, dashboard, lift gates, trunk, firewall, and interior kick panels.

8. The system of claim 4, wherein the basket is configured to have a head injury criterion (HIC) of less than 1,000 when impacted by the external object at a speed up to 25 km/hour, wherein the HIC is calculated by the following formula:
$$HIC = 0.75446 ( {[ \frac{1}{( {t}_{2} - {t}_{1} )} {\int }_{{t}_{2}}^{{t}_{1}} a d t ]}^{2.5} ( {t}_{2} - {t}_{1} ) ) + 166.4$$
and wherein the term a is the resultant acceleration of the external object expressed as a multiple of g (the acceleration of gravity), and t₁ and t₂ are any two points in time during the impact which are separated by no more than a 36 millisecond time interval.

9. The system of claim 1, wherein the groove has a larger radius than the basket.

10. The system of claim 1, wherein the groove partially or completely encircles the basket.

11. The speaker system of claim 1, wherein the groove runs generally parallel to the outer perimeter of the basket.

12. The speaker system of claim 1, wherein the basket is formed of a substance selected from one or more of the group consisting of, aluminum, steel, titanium, any other metal, plastic plastic composite, polypropylene, polycarbonate, and foam.

13. The speaker system of claim wherein the panel comprises:
a first, a second, and a third layer, wherein the second layer is between the first and third lavers and wherein the first and third layers comprise a same material and the second layer is an insulation layer.

14. The system of claim 13, wherein the first and second layers comprise fiberglass.

15. The speaker system of claim 13, wherein the groove is disposed on the first and second layers.

16. The speaker system of claim 1, wherein the groove has a diameter of about 200 mm.

17. The speaker system of claim 1, wherein the groove has a width of about 10 mm.

18. A speaker system for a vehicle comprising:
a speaker having basket configured to collapse upon impact with an external object; and
a headliner having a groove being disposed on a first side of the headliner, wherein the groove is adjacent to an outer perimeter of the basket where the basket is coupled to the speaker.

19. The speaker system of claim 18, wherein the basket is configured to have a head injury criterion (HIC) of less than 1,000 when impacted by the external object at a speed up to 25 km hour, wherein the HIC is calculated by the following formula:
$$HIC = 0.75446 ( {[ \frac{1}{( {t}_{2} - {t}_{1} )} {\int }_{{t}_{2}}^{{t}_{1}} a d t ]}^{2.5} ( {t}_{2} - {t}_{1} ) ) + 166.4$$
and wherein the term a is the resultant acceleration of the external object expressed as a multiple of g (the acceleration of gravity) and t₁ and t₂ are any two points in time during the impact which are separated by no more than a 36 millisecond time interval.

20. The speaker system of claim 18, wherein the groove has a larger radius than the basket.

21. The speaker system of claim 18, wherein the groove partially or completely encircles the basket.

22. The speaker system of claim 18, wherein the groove runs generally parallel to the outer perimeter of the basket.

23. The speaker system of claim 18, wherein the basket is formed of a substance selected from one or more of the group consistency of, aluminum, steel, titanium, any other metal, plastic, plastic composite, polypropylene, polycarbonate, and foam.

24. The speaker system of claim 18, wherein the headliner comprises:
a first, a second, and a third layer, wherein the second layer is between the first and third layers, and wherein the first and third layers comprise a same material and the second layer is an insulation layer.

25. The speaker system of claim 18, wherein the groove is disposed on the first and second layers.

26. The speaker system of claim 18, wherein the groove has a diameter of about 200 mm.

27. The speaker system of claim 18, wherein the groove has a width of about 10 mm.

28. The speaker system of claim 24, wherein the first and second lacers comprise fiberglass.
